(19) United States
(12) Patent Application Publication
(10) Pub. No.: US 2011/0130869 A1
(43) Pub. Date: Jun. 2, 2011

(54) Sorting Installation and Method for Sorting

(75) Inventors: Niels Linge, Pirmasens (DE); Andreas Luetz, Pirmasens (DE); Hans Gerhard Schehl, Pirmasens (DE); Volker Welsch, Pirmasens (DE); Werner Utzinger, Pirmasens (DE); Klaus Hickethier, Pirmasens (DE); Martin Mueller, Pirmasens (DE)

(73) Assignee: PSB INTRALOGISTICS GMBH, Pirmasens (DE)

(21) Appl. No.: 12/755,286

(22) Filed: Apr. 6, 2010

(30) Foreign Application Priority Data
Nov. 27, 2009 (EP) EP09177367.1

(51) Int. Cl. B65G 49/00; G06F 7/00

(52) U.S. Cl. 700/218; 700/230

(57) ABSTRACT

A sorting installation comprising a sorting area for sorting articles from source containers into target containers by a sorting person in a sorting area, a plurality of source container revolving conveyer devices adjacent to the sorting area, each of which being provided such that it supplies a plurality of source containers along a source container conveying circuit in a source container conveying circuit to the sorting person in the sorting area in a repeated and revolving manner until a predetermined number of articles are sorted from the respective source container into the respective target container, wherein the conveying circuit plane of the source container conveying circuit of the respective source container revolving conveyer device extends vertically and crosses the sorting area, a source container conveyer installation for automatically conveying source containers from an article storage to the source container revolving conveyer devices and for automatically conveying back source containers from the source container revolving conveyer devices to the article storage, and a target container conveyer system for supplying and removing target containers to and from the sorting area, wherein the target container conveyer system comprises a target container transport path which extends along the sorting area and adjacent to as well as at the front end side in front of the source container conveying circuits.

This patent application claims priority of European patent application number EP 09177367.1 filed on Nov. 27, 2009, which application is hereby incorporated by reference in its entirety.

### I. FIELD OF THE INVENTION

The invention relates to a sorting installation and a method for sorting articles from source containers into target containers.

Here, the term container includes any transport and/or storage means, such as boxes, cartons, etc., and also such means which do not enclose a hollow volume for receiving articles, such as pallets, hallstands, etc. Articles may be any kind of goods to be sorted, such as textiles, furniture (parts), machine elements, such as screws, nuts, springs, etc.

### II. BACKGROUND

Typically (and also in the context of the invention), articles to be sorted are arranged in source containers, also called storage containers, in an article store, such as a high-bay racking, to which a source container conveying installation, such as a storage and retrieval unit for high-bay warehouse with, for example, a path conveyer assigned thereto, is connected, by which the source containers are transported to a sorting area, in which a sorting person is located (that is, the sorting area is a standing or a seated working place), by whom articles are manually sorted from the source containers into target containers which are also called order containers (that is manual input of articles from source containers into target containers in accordance with a predetermined sorting plan). It is desired to provide the sorting area at small dimensions so that the sorting person does not have long distances between the source and target containers.

For today's high performance sorting systems it is usually desirable to achieve 1000 or more picks of articles per hour per sorting person (so-called picks per hour). That is, the sorting installation has to allow the respective sorting person (of a plurality of sorting persons) to pick 1000 or more articles per hour from diverse source containers and to sort them into diverse target containers.

A sorting installation is known from EP 2 098 464 A1, comprising a sorting area for sorting articles from source containers into target containers by means of a sorting person being in the sorting area, a plurality of target container revolving conveyer devices which are arranged adjacent to the sorting area, each of which is provided such that it supplies to the sorting person located in the sorting area a plurality of target containers along a target container conveying circuit extending in a conveying circuit plane in a repeated and revolving manner until the respective target container is loaded with articles from one or a plurality of source containers up to a predetermined degree, wherein the conveying circuit plane of the target container conveying circuit of the respective target container revolving conveyer device extends vertically and crosses the sorting area, a target container conveyer installation for supplying and returning target containers to/from the respective target container revolving conveyer device, and a source container conveyer system for conveying source containers from an article storage to the sorting area and for conveying back source containers from the sorting area to the article storage, wherein the source container conveyer system may also comprise at least one source container revolving conveyer device which is arranged adjacent to the sorting area, which is provided such that it supplies to the sorting person located in the sorting area a plurality of source containers along a source container conveying circuit extending in a conveying circuit plane in a repeated and revolving manner until a predetermined number of articles are sorted from the respective source container into the target containers, and may comprise a source container conveyer installation for supplying and returning source containers to/from the at least one source container revolving conveyer device, wherein the conveying circuit plane of the source container conveying circuit of the respective source container revolving conveyer device extends vertically and crosses the sorting area.

### III. SUMMARY OF INVENTION

The invention provides a sorting installation and a method for sorting articles, which allows efficient sorting with 1000 and more picks per hour per sorting person and an increased number of source containers to be handled, and wherein the sorting installation according to the invention is space and cost efficient.

A sorting installation according to an embodiment of the invention comprises a sorting area for sorting articles from source containers into target containers by a sorting person in a sorting area, a plurality of source container revolving conveyer devices arranged adjacent to the sorting area, each being provided such that it supplies a plurality of source containers along a source container conveying circuit in a conveying circuit plane to the sorting person in the sorting area in a repeated and revolving manner until a predetermined number of articles are sorted from the respective source container into the respective target container, wherein the conveying circuit plane of the source container conveying circuit of the respective source container revolving conveyer device extends vertically and crosses the sorting area, a source container conveyer installation for automatically conveying source containers from an article storage to the source container revolving conveyer devices and for automatically conveying back source containers from the source container revolving conveyer devices to the article storage, and a target container conveyer system for supplying and removing target containers to and from the sorting area, wherein the target container conveyer system comprises a target container transport path which extends along the sorting area and adjacent to as well as at the front end side in front of the source container conveying circuits.

The target container transport path of the target container conveyer system may extend at such a height level with respect to the source container conveying circuit that the target containers are accessible at the sorting area by the sorting person at approximately the same height level as the source containers, or for example at a height level below that of the source containers.

According to an embodiment, in the area of the sorting area the target container transport path may be tilted transversely to its conveying direction in a direction towards the sorting area and downwardly at a flat angle, for example at an angle between 5-35° with respect to the horizontal.

The source container revolving conveyer devices may be arranged adjacent to each other in a row with the conveying circuit planes parallel to each other, wherein the source container revolving conveyer devices may be aligned to each other at their front end side facing the sorting area, or may be arranged offset horizontally along their conveying circuit planes such that, in top view, they define an upside-down V-shape facing the sorting area, or may be arranged with their conveying circuit planes extending towards each other at an angle, for example at an angle of 90°, when seen in top view.

The source container revolving conveyer devices may be provided as modules identical to each other so that they may be arranged adjacent to each other in a row and/or replaced by each other in an arbitrary manner.

The source container revolving conveyer devices are attachable to and detachable from each other in a linearly guided manner, for example in the conveying direction of supply and return lines of the source container conveying circuits.

A plurality of source containers, for example at least four or at least six source containers, may be circularly conveyable in the respective source container conveying circuit.

The revolving operation of the respective source container revolving conveyer device may be reversible in its direction so that the source containers, which are in the corresponding source container conveying circuit, are selectively conveyed in the one or in the other revolving direction.

According to an embodiment of the invention, a method for sorting articles from source containers into target containers by a sorting person being in a sorting area, for example using a sorting installation as described herein, may comprise: by means of a plurality of source container revolving conveyer devices arranged adjacent to the sorting area and respectively having a source container conveyer circuit, wherein a conveying circuit plane of the source container conveying circuit of the respective source container revolving conveyer device extends vertically and crosses the sorting area, a plurality, for example a multiplicity, such as at least four or five or at least six, of source containers per source container conveying circuit are supplied to the sorting person in the sorting area along the respective source container conveying circuit in a revolving and repeated manner until a desired number of articles are sorted from the respective source container into respective ones of the target containers, wherein the target containers are automatically supplied to and are automatically removed from the sorting person on a target container transport path which extends adjacent as well as in front of that frontal side of the source container conveying circuit which faces the sorting area.

The method may further comprise: the source containers in the respective source container conveying circuit are conveyed towards the sorting area in the one or in the other revolving direction in dependence on their distance to the sorting area.

The target container transport path or also target container conveying path may, for example, be provided as a transport line, such as a roller line, but may also be provided in form of a carriage path, along which roller carriages with target containers are moved. The target containers and the source containers may be provided identical in construction and, thus, may be replaceable by each other. The source container conveying circuit of the respective source container revolving conveyer device may comprise two linear conveying paths arranged in a vertical distance to each other and, for example, being parallel, and having a respective drive for automatically moving the source containers, and may comprise a respective lift device at the ends of the linear conveying paths for automatically transferring the source containers from the one to the respective other linear conveying path, wherein the drive of the lower linear conveying path, for example, is provided as a gravity force drive, and wherein the drive of the upper linear conveying path, for example, is provided as an electric motor drive. Further, the respective source container revolving conveyer device may comprise several carriers, such as carrier plates, fixedly provided in the source container conveying circuit and revolving therewith and for receiving the source containers.

Since, according to the invention, a plurality of source containers are continuously supplied to the sorting person in the sorting area in a revolving and repeated manner, it is possible to sort a multiplicity of different articles from a multiplicity of source containers into the target containers. Thereby, the invention can also comply with the increased conveying capacities of a so-called shuttle article storage (for example, provided in form of a shuttle high-bay racking), with which an enormous turnover (transferring to and releasing from stock of source containers in the article storage) is possible. The article storage is typically arranged remotely from the sorting installation, wherein the source containers are automatically bi-directionally conveyed between the article storage and the source container revolving conveyer devices by means of a source container conveyer system, for example via conveying paths provided by conveying lines (such as roller or belt lines).

The sorting process is highly efficient (high pick rate), since in connection with the circulation of the source containers it can be sorted continuously. According to an embodiment, the sorting installation does not include any target revolving conveyer devices which are designed and arranged in correspondence with the source container revolving conveyer devices, but the target containers are only transported or conveyed to/from the sorting area for sorting via the target container transport path provided on the front end side of the source container revolving conveyer devices.

The target container transport path extends transversely to the conveying circuit planes of the source container conveying circuits as well as closely and adjacently along and in front of the front end sides/front ends of the source container revolving conveyer devices. The sorting area in turn extends immediately in front of and, thus, contiguously to the target container transport path. Thus, the goods can be taken by the sorting person in the sorting area from the source containers, which are conveyed in the source container conveying circuits, most proximal to the sorting area and can be immediately sorted into the target containers conveyed in front thereof and along the sorting area on the target container transport path.

When the target container being on the target container transport path is loaded with the desired number of articles from the diverse source containers supplied thereto, for example with all articles to be finally sorted into the target container, it is further transported on the target container transport path, for example directly to the ordering person, to a distribution installation, to a shipping installation or also to another sorting installation, by means of which it will be further loaded. In this respect, it is possible to predetermine a lower loading degree (compared to the finally loaded container) for the respective target container on the target container transport path. For example, the respective target container may only be loaded with articles of a single type or of a defined number of types of one or more source containers assigned to this article type and then be supplied via the target container transport path to another, correspondingly structured sorting installation, where it is then further loaded in accordance with the invention with another article of another source container by the sorting person located there. This way of proceeding may be repeated until the finally completed loading of the respective target container is achieved.

The source containers may contain/carry articles of one type (i.e., mono-material source container) or may also contain/carry a plurality of articles of different types. Accordingly, containers may, for example, contain pieces of clothing (i.e., article) of different colours (type) or pieces of clothing (i.e., article) of different kind (type) such as trousers, blouse, T-shirt. In this respect, the sorting person receives clear instructions via a display, which article and/or which article type and/or which amount of this article type is to be loaded into the respective target container.

The sorting area is to be understood as that area in which the sorting person is located and/or moves for sorting the articles from the source containers into the target containers. That is, the sorting area forms the working area/working space of the sorting person. The sorting area is typically formed as a horizontal surface, on which the sorting person stands or is seated via a seating-accommodation. Since the conveying circuit plane (imaginarily) extends through the sorting area, the sorting area is correspondingly located on the front end side of the conveying circuit, that is, of the conveying loop, wherein the source containers in the respective conveying circuit are frontally conveyed to the sorting area on a supply line and are frontally conveyed away from the sorting area on a return line.

The empty target containers are automatically supplied, for example from an empty target container collection location, via the target container conveyer system to the sorting area, that is, to the target container transport path located there, and the loaded target containers are automatically transported away from the sorting area by the conveyer system. Source containers which may be partially filled with articles are automatically returned from the sorting area to the article storage via a source container supply conveyer installation which together with the source container revolving conveyer devices of the sorting installation(s) forms a source container conveyer system. Empty source containers may, for example, be manually taken away from the conveyer system at the sorting area and be brought to a source container collection location, or may be automatically transported away from the sorting area and, for example, be automatically taken away between the storage and the sorting area and transported to the empty source container collection location. There is also the possibility to directly further use empty source containers as target containers, for example, by transferring empty source containers from the source container conveying circuit to the target container transport path.

The respective source container revolving conveyer device may be provided as a paternoster device, in which the containers are suspended on a revolving strand, for example a revolving chain, which, for example, is driven by an electric motor. Further, the source container revolving conveyer device may also be provided as a pushing mechanism, comprising two substantially horizontal and substantially linear conveying paths which are arranged at a vertical distance one above the other, wherein one of which forms a supply line and the other one forms a return line (that is, supplying and returning with respect to the sorting area), wherein at the ends of the linear conveying paths there is respectively provided a transfer device in the form of a lift device in order to transport the source containers from the return line to the supply line and/or the other way around. The revolving operation can be provided reversible in its conveying direction. That is, the upper conveying path may be selectively a supply line or a return line. The same accordingly applies for the lower conveying path. This provides the possibility that depending on the distance of a source container, which is in the source container revolving conveyer circuit, to the sorting area, this source container, on request (that is, if, for example, according to a control program it is requested that now it is to be sorted from this source container) can be conveyed to the sorting area either in the one or in the other revolving direction. In this respect, it will be conveyed in that revolving direction which corresponds to the shortest distance, whereby the conveying time can be further reduced and, hence, the efficiency of the sorting installation can be further increased.

The drive for driving the substantially horizontal conveying paths may be provided as electric motor drive. A respective gravity drive is also possible, wherein the conveying paths then, for example, are inclined about 3-5° relative to the horizontal (such small inclinations are still to be interpreted to be substantially horizontal). Both conveying paths may be slightly inclined so as to slope towards the sorting area so that the conveying path, which is used for returning containers, should be provided with an additional drive for overcoming the gravity. It is also possible to supply the source containers on the lower conveying path via gravity (for example, via the conveying path being inclined by 3-5°) and to manually push back the source containers on the upper conveying path, for which the upper conveying path, for example, may be provided as a non-inclined horizontal roller path, wherein, however, an automatic drive (including gravity drive) provides increased efficiency. At that front end of the conveying paths, which faces the sorting area, the vertical transfer of the source container from the one conveying path to the other conveying path may be carried out manually. However, for achieving increased efficiency, at both front ends of the source container revolving conveyer device there may be provided electric motor driven lift devices for transferring the source containers from the one to the other conveying path, that is, from the one to the other line.

The upper conveying path is, for example, arranged on a working level (approximately 1100 mm above ground level) or somewhat thereabove (1200 mm-1300 mm) so that the sorting person has easy access to that source container of the source container revolving conveyer device, which is positioned at that end of the upper conveying path of the source container revolving conveyer device, which faces the sorting person. The target container transport path extends, for example, maximally at the height level of the upper conveying path of the respective source container revolving conveyer device or therebelow, whereby it can be sorted in an ergonomically appropriate way from the source containers arranged further above into the target containers arranged further below with regard to the source containers.

In case of a plurality of source containers, for example six or more source containers, per conveying circuit the source container revolving conveyer device, for example, extends with its upper conveying path (for example, with the return line) and with its lower conveying path (for example, with the supply line) in a manner to be substantially elongate in the horizontal direction so that source containers are transported to and correspondingly away from the sorting person in the sorting area in a substantially horizontal manner.

Thus, the source containers revolve in a source container conveying circuit, that is, in a source container conveying loop, which defines a conveying circuit plane which, in accordance with the invention, extends through the sorting area. (That is, the imaginary plane, but not the conveying circuit with the source containers as structure, extends through the sorting area). This has the effect that, when seen by the sorting person located on the front end side of the corresponding conveying circuit, that is, on the front end side of the corresponding conveying loop, the source container revolving device can be structured in a very narrow manner, that is, can be structured with a small width. In this respect, the width of the source container revolving conveying device is, for example, adapted to the width of the corresponding source container. For example, the source containers having a width of 400-500 mm may be transported by means of a correspondingly wide source container revolving conveyer device.

This provides the possibility to arrange a plurality of source container revolving conveyer devices, with their conveying circuit planes being parallel to each other, adjacent to each other in a row, which can be operated by the same sorting person, since the sorting area is all in all kept very small. The width of the sorting area corresponds to the overall width of the source container revolving conveyer devices. In this respect, it is also possible to arrange four to six or even more source container revolving conveyer devices in parallel to each other and adjacent to each other in a row for operation by one sorting person.

According to an embodiment, the source container supply conveyer installation comprises a source container supply transport path, for example in form of a roller path, by which the source containers are transported from the article storage to the respective source container revolving conveyer device, in order to be transferred there, on request, to the respective source container revolving conveyer device by means of a transfer device. Further, the source container supply installation may comprise a source container return transport path, for example in form of a roller path, onto which source containers are transferred from the source container revolving conveyer device by means of a transfer device, in order to be transported back to the article storage. The source container supply transport path and the source container return transport path may also be provided as a single transport path. A sensor device, for example a bar code or RFID tag scanner, for example recognizes whether, when, where and how a source container is to be supplied/returned, in order to then control forwarding systems/transfer systems for carrying out the necessary transfer processes.

The source container supply conveyer installation may comprise one or a plurality of storage access devices, for example a storage and retrieval unit/vehicle for high-bay warehouse, in order to access the source containers stored in the article storage and to then supply the source containers to the further transport installations of the source container conveyer system for being supplied to the source container revolving conveyer device.

The respective source container revolving conveyer devices, which are provided as modules, are, for example, connected to each other in a manner to be moveable relative to each other in a guided manner of drawer type, for example, by means of engaged guiding rails/longitudinal grooves including sliding or roller bearings. The guiding axis, for example, extends substantially horizontally and parallel to the upper and lower conveying paths. However, also plug connections between the modules are possible, wherein the respective modules are connected to each other in a plugged or snap-fit manner in a direction transverse to the conveying circuit planes. In this respect, the drawer system would have the effect that centrally arranged modules would be more easily replaceable by means of drawing out the respective module and sliding back the module into the module combination block.

The respective source container revolving conveyer device may have as substantially horizontal conveying paths, for example, two roller paths or two roller supported transport belts with freely rotating and/or motor driven rollers, onto which the source containers can be directly placed. The lift devices may be gripper arms which grip the source containers at the front end of the conveying circuit and transfer them freely. The lift devices may also be lift platforms which can be brought in alignment to the respective conveying path so that the conveying path can directly convey the containers onto the platform. There may also be carrying means fixedly integrated in the conveying circuit, such as carrying plates, onto which the source containers can be placed. The carrying plates are continuously transported in a revolving manner, for example via roller paths in the substantial horizontal, wherein at the end of the respective line, that is at the end of the respective substantially horizontal conveying path, the carrying plates roll or are pushed onto a lift device in order to be lifted or lowered to the conveying path above or below, respectively, where they are then pushed from the lift device to this conveying path.

The invention further relates to a combination of a sorting installation as described in this application with a shuttle high-bay racking which has a plurality of rack corridors, a plurality of rack levels and one or more shuttles per rack corridor, wherein the shuttles can be moved in any one of the rack levels along the corresponding rack corridor in a guided manner and wherein source containers with articles can be reciprocally transported on the shuttles between the rack storage locations of the shuttle high-bay racking and the source container conveyer system.

### IV. BRIEF DESCRIPTION OF DRAWINGS

The drawings are not necessarily to scale, emphasis instead generally being placed upon illustrating the principles of the invention. In the following description, various embodiments of the invention are described with reference to the following drawings, in which:

FIGS. 1 and 2 show perspective schematic illustrations of sorting installations according to embodiments of the invention,

FIGS. 3 and 4 show a schematic top view and a schematic side view, respectively, of the sorting installation according to FIG. 1 and FIG. 2, respectively,

FIGS. 5, 6 and 7 respectively show a schematic side view of a module of a sorting installation according to embodiments of the invention, and

FIGS. 8 to 11 show schematic top views of further embodiments of the invention.

In the figures similar reference signs are used for similar elements.

### V. DETAILED DESCRIPTION OF THE INVENTION

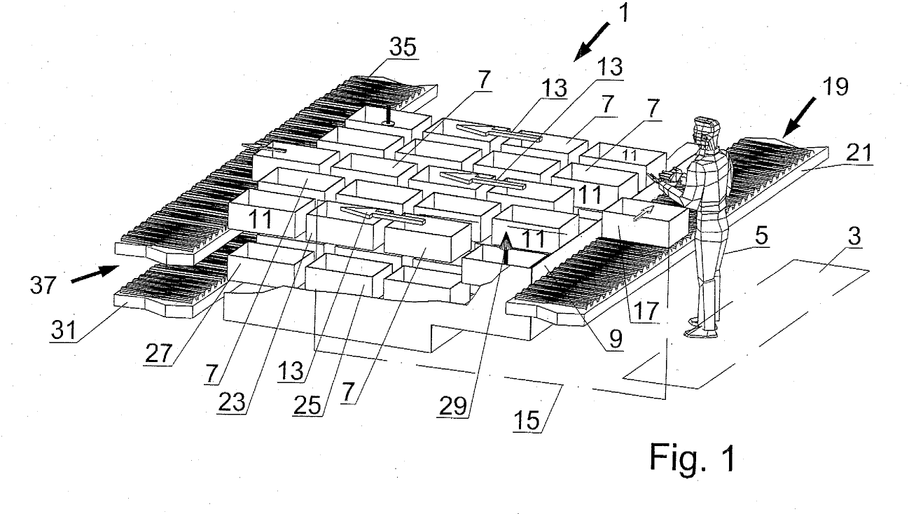

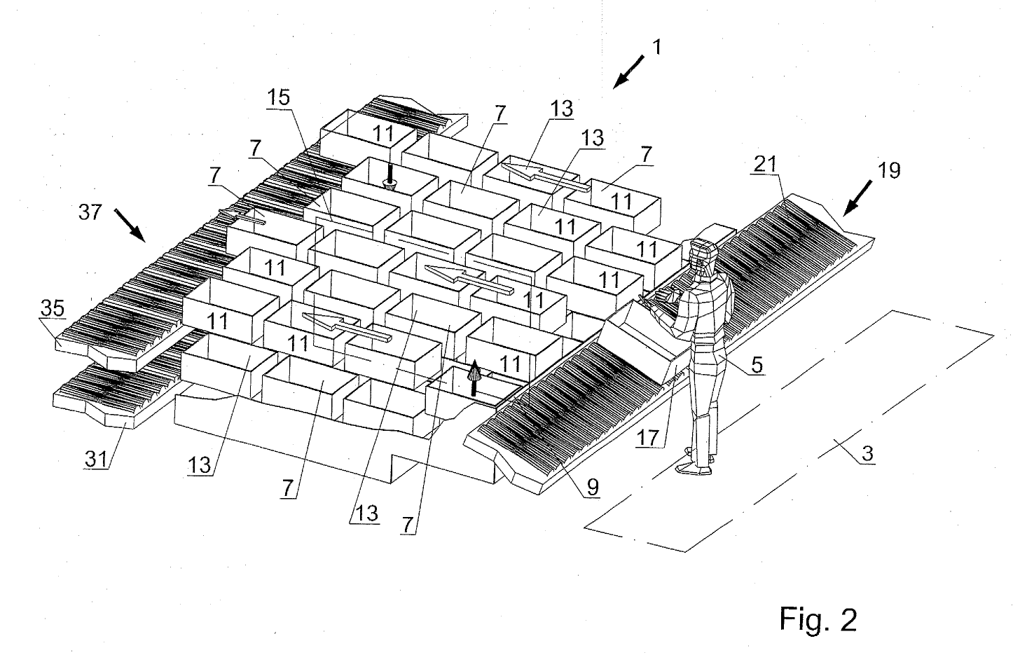

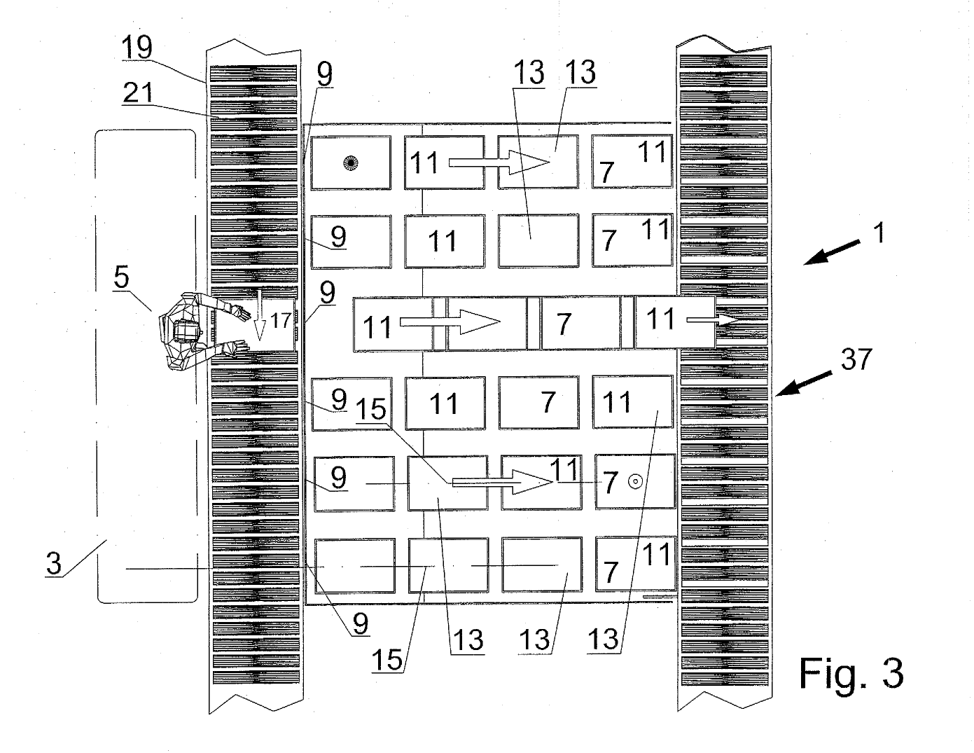

In FIGS. 1 to 4, a sorting installation according to an embodiment of the invention is depicted, comprising a sorting area 3 provided as a horizontal elongate standing surface, in which a sorting person 5 is located, and comprising five (FIG. 1) or six (FIGS. 2 and 3), respectively, source container revolving conveyer devices 7 which are arranged parallel to each other and which, with their one front end side 9, are arranged adjacent to the sorting area 3 and in which respectively a plurality of box-shaped source containers 11 are provided in a manner so as to vertically revolve in a conveying circuit 13, that is in a conveying loop. The respective conveying circuit 13 extends in a respective vertical conveying circuit plane 15. The vertical conveying circuit planes 13 of the source container revolving conveyer devices 7 extend parallel to each other.

The articles (not shown) in the source containers 11 will be sorted by the sorting person in accordance with a displayed sorting plan into the target containers 17 which are automatically supplied to and transported away from the sorting person 5 in the sorting area 3 by means of a target container transport path 21 assigned to a target container conveyer system 19. The target container transport path 21 extends on the front end side 9, facing the sorting area 3, of the source container revolving conveyer devices 7 in front of the latter along the sorting area 3. In this respect, the target container transport path 21 is arranged on such a height level that the target containers 17 transported thereon along the sorting area 3 are arranged at about the same height level as those source containers 11 in the source container revolving conveyer devices 7, to which the sorting person 5 has access for taking out articles to be sorted (in this case these are the source containers 11 arranged on the one front end side 9 and upper side on the conveying circuit 13). In the embodiment shown in FIG. 2 the target container transport path 21 is inclined in its transverse direction toward the sorting area 3 so that the sorting person has easier access to the target containers 17.

In addition to the target container transport path 21, the target container conveyer system 19 may further comprise a target container conveyer installation (not shown), by which empty target containers 17 are supplied to the target container transport path 21 and the target container conveyer installation (not shown) takes away the loaded target containers 17 from the target container transport path 21 and further transports them, for example for delivery. In this respect, the target container conveyer installation may comprise usual transport and transfer units, such as gripping devices, etc. The target container transport path 21 may also be an integral component (for example in form of a transport path branch) of the target container conveyer device.

The respective source container revolving conveyer devices 7 respectively are structurally identical to each other, including identical containers 11 which may also be identical to the target containers 17 so that the source containers 11 may also be used as target containers 17 and the other way round.

The sorting area 3 extends frontally adjacent to and in front of the source container revolving conveyer devices 7 and extends in front of the target container transport path 21 in an abutting manner or in a manner immediately adjacent thereto, and has a length corresponding to the overall width of the source container revolving conveyer devices 7. The respective conveyer circuit plane 15 crosses the sorting area 3 so that the sorting area 3, the sorting person 5 being in the sorting area 3 and the target container transport path 21 are positioned at the one frontal end 9 of the respective conveyer circuit 13, where also the one (vertical) turning location 29 of each of the source container revolving conveyer devices 7 is provided. The respective target container 17 and the respective source container 21, for example, have the dimensions of 600 mm×400 mm×200 mm (length×width×height), wherein, in this respect, the width of the respective source container revolving device 7 may be about 500 mm so that in this case the overall width of the source container revolving devices 7 and, thus, the length of the sorting area 3 amount to about 2500 mm.

Since the source container revolving conveyer devices 7 are structurally identical to each other, they form modules which can be easily replaced by each other. It is also possible to add or to remove further of these modules. The modules are assembled together in a modular manner, for example via longitudinal guides which extend substantially horizontally and parallel to the supply and return conveying directions (see below) of the source container revolving conveyer devices 7.

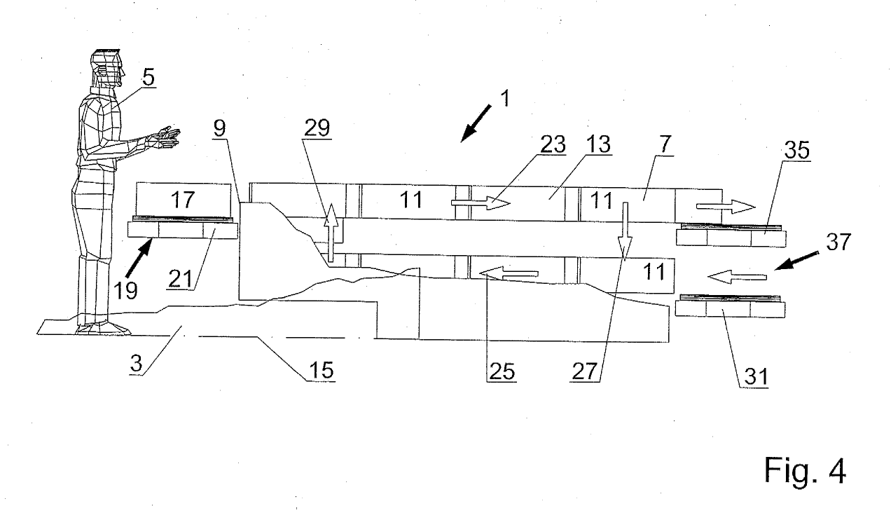

In the following, only the source container revolving conveyer device 7 on the left-most side in FIG. 1 is described in further detail (also see FIG. 4), wherein this description also applies for all other modules.

The source container revolving conveyer device 7 comprises an upper conveying path 23 which extends substantially horizontally and substantially linearly, and which in this case is provided as a return line, on which source containers 11 are carried away from the sorting area 3. The upper conveying path 23 extends at such a height level that the source containers 11 conveyed thereon are arranged in a working height level of about 1100 mm. The sorting person 5 currently can take out articles, which are to be sorted into the target container 17, from that source container 11 on the upper conveying path 23, which is closest to the sorting area 3. The source container revolving conveyer device 7 further has a lower substantially horizontally and substantially linearly extending conveying path 25, which is provided as a supply line and on which the source containers 11 are supplied to the sorting area 3 vertically below the return line.

Thus, the source containers 11 are conveyed in the lower conveying path 25 in a substantially horizontal manner towards the sorting area 3 and towards the sorting person 5, and are conveyed in the upper conveying path 23 in a substantially horizontally manner away from the sorting area 3 and from the sorting person 5. As an alternative, it can be conveyed towards the sorting area 3 on the upper conveying path 23 and can be conveyed away from the sorting area 3 on the lower conveying path 25. A reversal operation is also possible.

A first turning location 27, which faces away from the sorting area 3, in the conveying circuit of the source container revolving conveyer device 7 is provided with a lift device (not shown), by which source containers 11 are automatically, for example by means of an electric motor drive, transferrable from the upper conveying path 23 (return line) to the lower conveying path 25 (supply line) for maintaining the revolving operation. The second turning location 29, which faces the sorting area 3, in the conveying circuit 13 of the source container revolving conveyer device 7 is also provided with a lift device (not shown), which is, for example, structurally identical to the first-mentioned lift device, in order to automatically, for example via an electric motor drive, transfer the source containers 11 from the lower conveying path 25 (supply line) to the upper conveying path 23 (return line) for maintaining the revolving operation. In principle, the lift device at the front end 9 facing the sorting person 5 may also be omitted, and the container may be manually transferred from the supply line to the return line. However, this may provide decreased efficiency. The source containers 11 may be respectively driven by means of an electric motor on the upper as well as on the lower conveying paths 23, 25. The whole revolving operation may also be reversible in the conveying direction.

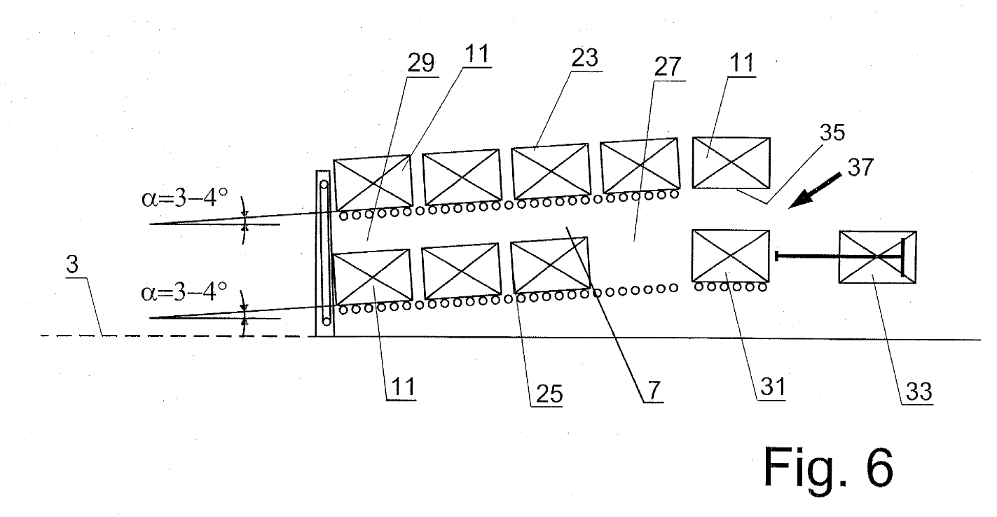

FIG. 6 shows an embodiment of a source container revolving conveyer device 7, in which the lower and the upper conveying paths 23, 25 extend between the first and the second turning locations 27, 29 in a manner inclined towards the sorting area 3 at a predetermined angle, for example 3°-4° or 5°. (In this respect, this is still considered to be substantially horizontal). Due to the inclination, the lower conveying path 25 is provided with a gravity drive means towards the sorting area 3, so that a motor drive may be omitted. However, the upper conveying path 23 has to be provided with a drive, for example, an electric motor drive, for overcoming the gravity in order to carry away the source containers 11 from the sorting area 3. Such a drive may also be provided by manual force. That is, the sorting person may push back the abutting source containers 11 along the upper conveying path 23 which, for example, is provided as a roller transport path. For example, the upper conveying path 23 is provided with a motor drive, for example with an electric motor drive, to return the source containers 11 from the sorting area 3. It is also possible that the upper conveying path 23 is inclined at a predetermined angle away from the sorting area 3, for example at an angle of 3°-4° or 5°, so that the source containers 11 are also returned via gravity from the sorting area 3.

The supply of source containers 11 from a remotely arranged article storage (not shown) to the respective source container revolving conveyer device 11 is provided, according to the embodiments of FIGS. 1 to 6, by means of a lower roller transport path 31 which extends at the height level of the lower conveying path 25 of the respective source container revolving conveyer device 7 as well as extends adjacent to the turn location 27 thereof remote from the sorting area 3 at the corresponding front end side thereof. Therefore, for example by means of a pushing device 33, such as a pressure operated, for example hydraulic or pneumatic, pushing cylinder, a source container 11 may be directly transferred from the lower roller transport path 31 to the source container revolving conveyer device 7, that is, it can be directly pushed onto the lower conveying path 23 thereof. The return of source containers 11 from the respective source container revolving conveyer device 7 back to the article storage may be provided by means of an upper roller transport path 35 which extends in parallel and in a vertical distance to the lower roller transport path 31. The transfer of the respective source container 11 from the upper conveying path 25 to the upper roller transport path 35 may be provided, for example, by the drive of the upper roller conveying path 25. In this respect, when using a gravity drive, a mechanical stopper may be provided, which prevents the source container 11 from accidentally moving from the source container conveying circuit 16 to the upper roller transport path 35. In accordance with the embodiments of the invention of FIGS. 1 to 6, the upper and lower transport paths 31 and 35 form a source container supply conveyer installation 37 for supplying and returning source containers 11 from/back to the article storage to the respective/from the respective source container revolving conveyer device 7. The source container supply conveyer installation 37, that is, the transport paths 31, 35 thereof, extend transverse to the conveying circuit planes 13. The source container supply conveyer device 37 and the source container revolving conveyer devices 7 together form a source container conveyer system for automatically and reciprocally transporting source containers 11 and, hence, articles between the article storage and the sorting area 3.

The transport roller paths 31, 35 of the source container conveyer installation 37 as well as the target container transport paths 45 may also be provided in form of transport belts or also in form of transport carriages which are guided along a path. A storage and retrieval unit for a high-bay warehouse may also be directly assigned to the respective sorting installation 1, which directly grips respective source containers from the storage and inserts them in/takes them out of the source container revolving conveyer device 7. The same may be applied to the target container transport path 45 with respect to an empty target container storage and a storage or a shipment completion location for finally loaded target containers. That is, empty target containers 17 may also be taken away from an empty target container storage by means of a gripper arm and may be transported by the gripper arm to directly in front of the source container revolving conveyer devices 7 at the front end side thereof for being loaded, in order to be then further transported by means of a gripper from there, for example, to a dispatch conveyer system. In this case, the motion path of the gripper quasi forms the transport path for the target container 17.

The operation of the sorting installation 1 may, for example, be as follows: source containers 11 are supplied to the respective source container revolving conveyer device 7 by means of the source container conveyer installation 37 until the respective source container revolving conveyer device 7 is respectively and completely loaded with source containers 11 (with seven in FIG. 1). However, it is not necessary to completely load the source container revolving conveyer device 7. It may also already be started with sorting when the first source container 11 is located on the frontal upper position, that is, when it is located in a manner facing the sorting area 3 and being accessible to the sorting person 5. In this respect, for example, it may be detected by means of a sensor device how many articles are available in the respective source container 11. And if the number of available articles is smaller than the number of articles which are to be sorted into the target container 17 or into the group of target containers 17 which are currently to be loaded, then, for example, a plurality of source containers of this article type may be inserted in the respective source container revolving conveyer device 7.

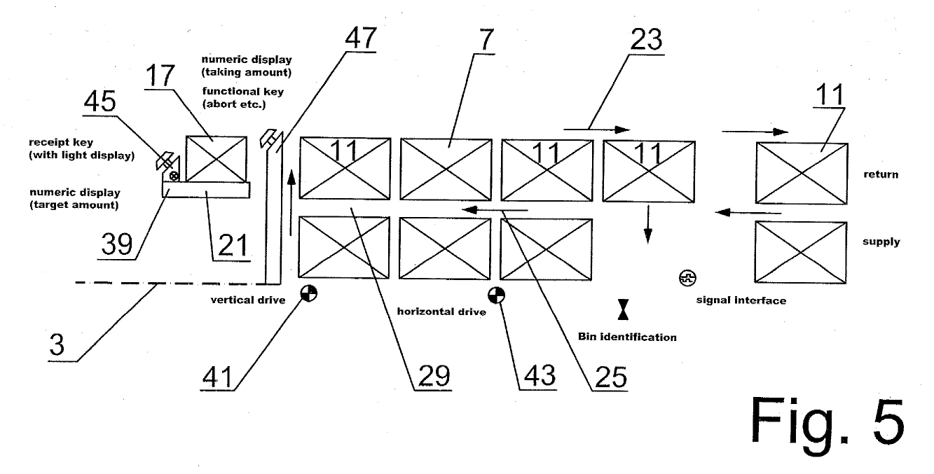

The sorting person 3 then sorts, in accordance with a desired sorting plan which will be displayed to the sorting person via a display (cf., for example, 39 in FIG. 5), articles from the source containers 11, revolving in the source container revolving conveyer devices 7, into the target containers 17 which will be supplied to the sorting person via the target container transport path 21.

FIG. 5 shows schematically a source container revolving conveyer device 7 provided as a module in accordance with an embodiment of the invention. The embodiment of the source container revolving conveyer device 7 is similar to that shown in FIGS. 1 and 4. In FIG. 5, the abbreviation “THM” means “auxiliary transport means” and, thus, refers to source containers 11. Further, in FIG. 5, different drives are shown for the revolving operation. In this respect, an electric vertical motor drive 41 is provided at the turning location 29 facing the sorting area, and an electric horizontal motor drive 43 is provided in the lower conveying path 25. Further, diverse sensors are mounted for monitoring the occupancy and the further operation of the source container revolving conveyer device 7. An operation panel 45 is arranged at the front end side and adjacent to the turning location 29 in a manner facing the sorting area 3, namely it is arranged immediately adjacent and in front of the target container transport path 21 and has function buttons for operating the sorting installation 1, including, for example, an emergency switch, and has the display 39. A further operation panel 47 is arranged between the target container transport path 21 and the source container revolving conveyer devices 7, on which there are also arranged function buttons for further operation of the sorting installation.

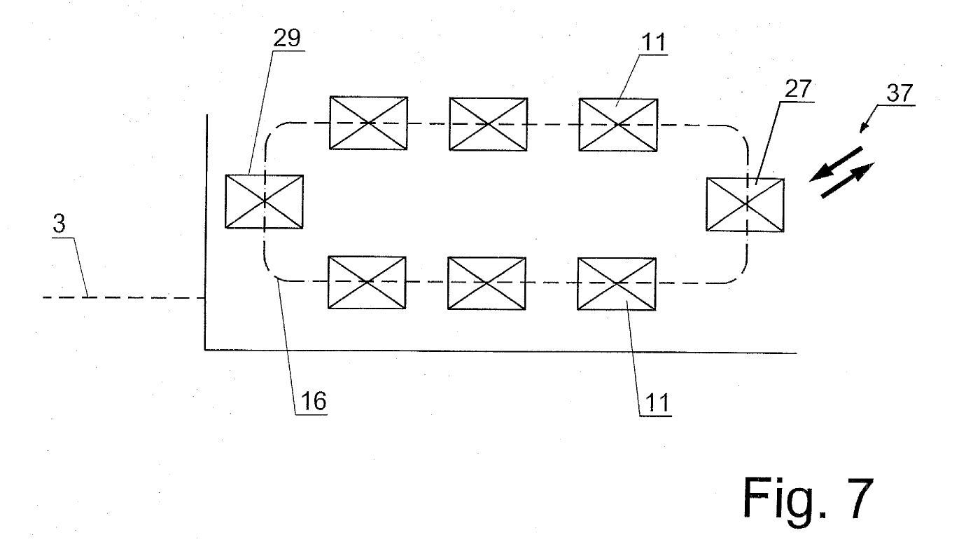

FIG. 7 shows schematically another revolving principle for the source containers 11 as an alternative to the pushing/lifting principle according to FIGS. 1-6. That is, the source containers 11 in this case are transported according to the paternoster principle and are suspended in a revolving line, whereby only one drive device is required for driving the line and the lifting devices are omitted. The source container 11 that is located on the left side turning location 29 in FIG. 7 can be accessed, for unloading, by a sorting person standing in the sorting area 3 at the front end side of the conveying circuit 13. The source containers 11 can be inserted in the paternoster and can be taken out therefrom at the right side turning location 27 in the FIG. by means of a mechanism 37.

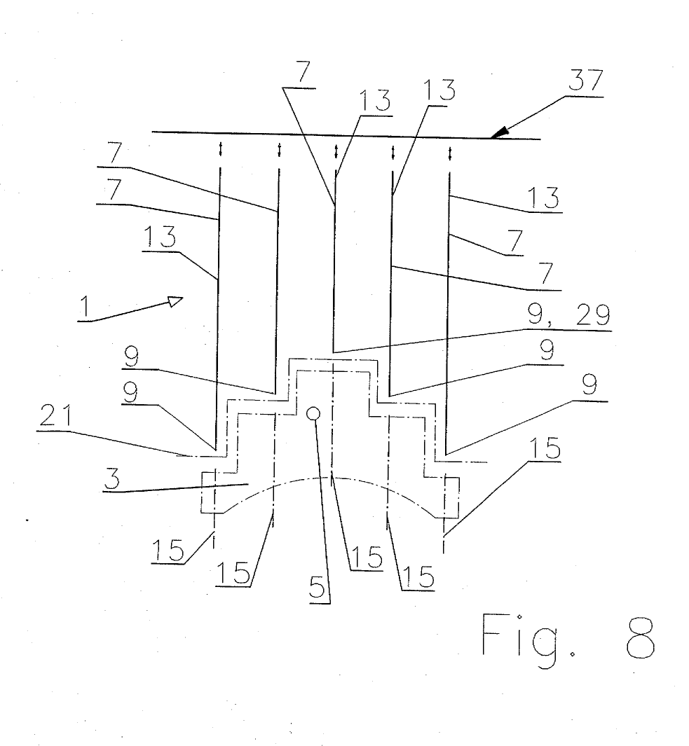

The embodiments shown in FIGS. 1 to 4 of the sorting installation 1 according to the invention show their source container revolving conveyer devices 7 in manner so as to be aligned, at the front end side 9 facing the sorting area 3, in direction perpendicular to the conveying circuit planes 15. In this respect, FIGS. 8-11 show alternative embodiments of the invention.

For example, in the sorting installation 1 according to the embodiment of FIG. 8, five source container revolving conveyer devices 7 extend parallel to each other with their conveying circuit planes 15 being parallel to each other. However, the front end sides 9 of the respective conveying circuits 13 facing the sorting area 3 are arranged offset relative to each other when seen in top view in a manner so that they form an upside down V-shape facing the sorting area 3. Therefore, in this embodiment, a sorting person 5 has horizontal front end side access to that source container 11 which is positioned on the front end side on the centrally arranged source container revolving conveyer device 7, and also has horizontal lateral access to the source containers 11 which are arranged on the front end sides of that source container revolving conveyer devices 7 which are arranged laterally of the central source container revolving conveyer device 7. In this embodiment, the target container transport path 21 extends in a step-like manner along the front ends 9, facing the sorting area 3, of the sorting container revolving conveyer devices 7.

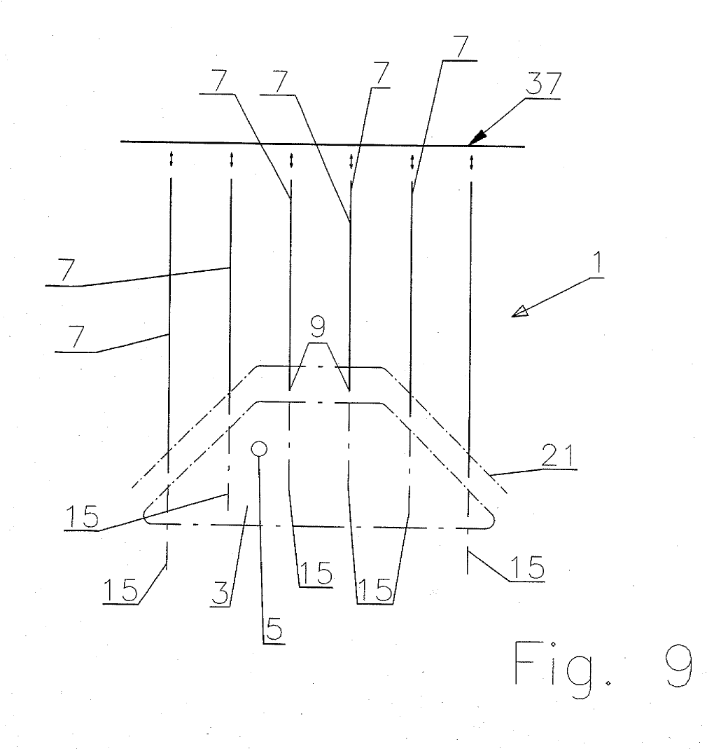

The embodiment of a sorting installation 1 shown in FIG. 9 provides an alternative to the embodiment shown in FIG. 8 and comprises two centrally arranged source container revolving conveyer devices 7 which are aligned to each other at their frontal end 9 facing the sorting area and comprises respective two lateral source container revolving conveyer devices 7 which project further beyond in a step-like manner so that seen in top view an extended V-shape or a pan shape is formed. In this embodiment, seen in top view, the target container transport path 21 correspondingly extends in a pan-shape in front of the front ends 9, facing the sorting area 3, of the source container revolving conveyer devices 7. The two central (imaginary) conveying circuit planes 15 frontally cross the sorting area 3, and the respective two lateral (imaginary) conveying circuit planes 15 cross the sorting area in an inclined manner at an angle defined by the V-shape.

In the embodiments according to FIGS. 8 and 9, the supply/return of source containers to/from the source container revolving conveyer devices 7 is provided via a source container conveyer device 37 which extends along the frontal ends, facing away from the sorting area 3, of the source container revolving conveyer devices 7.

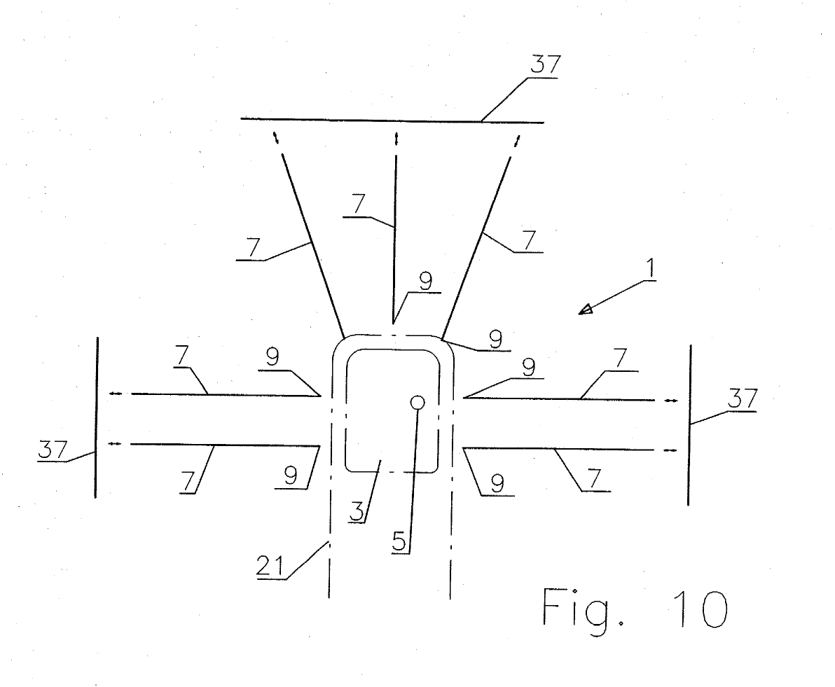

In the embodiment of a sorting installation 1 shown schematically in FIG. 10, the source container revolving conveyer devices 7 convey in a fan-like manner towards to and away from the centrally arranged sorting area 3, wherein the supply/return of source containers is provided via source container conveyer installations 37 which extend on the front ends, facing away from the sorting area 3, of the source container revolving conveyer devices 7. Also a star-shaped arrangement of the source container revolving conveyer devices 7 with respect to the centrally arranged sorting area 3 is possible. In this embodiment, the target container transport path 21 extends along and in front of the frontal ends 9, facing the sorting area 3, of the source container revolving conveyer devices 7 in a U-shaped manner.

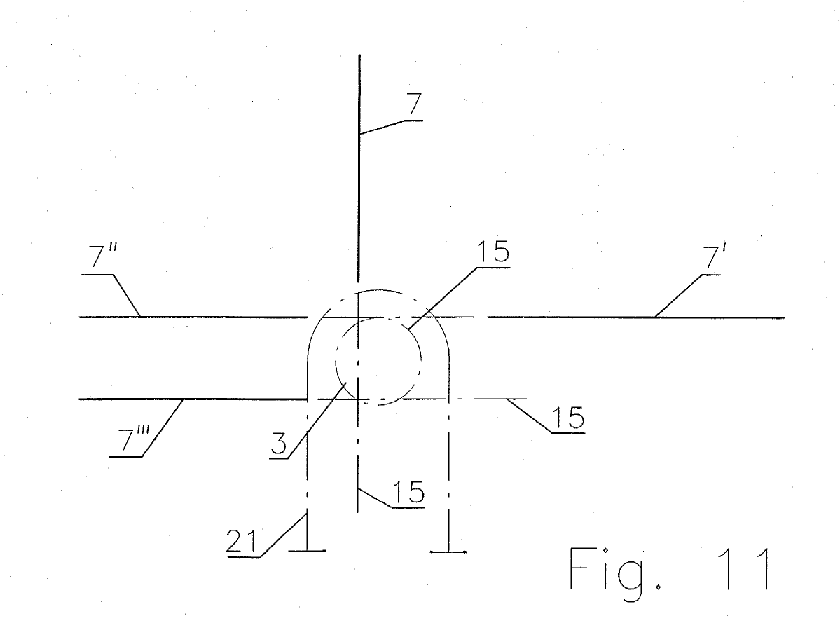

A further embodiment is shown schematically in FIG. 11 in a top view, wherein first and second source container revolving conveying devices 7, 7′ extend, with their conveying circuit planes 15, perpendicular to each other, and a third source container revolving conveying device 7″ and a fourth source container revolving conveying device 7′″ extend parallel to each other and perpendicular to the first 7 and parallel and opposite to the second target container conveying device 7′. According to the invention, the sorting area 3 is then centrally located at the intersection of the conveying circuit planes 15 of the revolving conveying devices 7, 7′, 7″, 7′″. The target container transport path 21, as also in the embodiments above, correspondingly extends between the sorting area 3 and the front ends, facing the sorting area 3, of the source container revolving conveyer devices 7.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A sorting installation comprising
a sorting area for sorting articles from source containers into target containers by a sorting person in a sorting area,
a plurality of source container revolving conveyer devices arranged adjacent to the sorting area, each of which being provided such that it supplies a plurality of source containers along a source container conveying circuit in a conveying circuit plane to the sorting person in the sorting area in a repeated and revolving manner until a predetermined number of articles are sorted from the respective source container into the respective target container, wherein the conveying circuit plane of the source container conveying circuit of the respective source container revolving conveyer device extends vertically and crosses the sorting area,
a source container conveyer installation for automatically conveying source containers from an article storage to the source container revolving conveyer devices and for automatically conveying back source containers from the source container revolving conveyer devices to the article storage, and
a target container conveyer system for supplying and removing target containers to and from the sorting area, wherein the target container conveyer system comprises a target container transport path which extends along the sorting area and adjacent to as well as at the front end side in front of the source container conveying circuits.

2. The sorting installation according to claim 1, wherein the target container transport path of the target container conveyer system extends at such a height level with respect to the source container conveying circuit that the target containers are provided to be accessible at the sorting area by the sorting person at approximately the same height level as the source containers or at a height level below that of the source containers.

3. The sorting installation according to claim 1, wherein in the area of the sorting area the supply transport path is tilted transversely to its conveying direction in a direction towards the sorting area and downwardly at a flat angle.

4. The sorting installation according to claim 3, wherein the flat angle is in the range of between 5-35°.

5. The sorting installation according to claim 1, wherein the source container revolving conveyer devices are arranged adjacent to each other in a row with the conveying circuit planes parallel to each other, wherein the source container revolving conveyer devices are aligned to each other at their front end side facing the sorting area.

6. The sorting installation according to claim 1, wherein the source container revolving conveyer devices are arranged adjacent to each other in a row with the conveying circuit planes parallel to each other, wherein the source container revolving conveyer devices are arranged offset horizontally along their conveying circuit planes such that, in top view, they define an upside-down V-shape facing the sorting area.

7. The sorting installation according to claim 1, wherein the source container revolving conveyer devices are arranged adjacent to each other in a row with the conveying circuit planes parallel to each other, wherein the source container revolving conveyer devices are arranged with their conveying circuit planes extending towards each other at an angle.

8. The sorting installation according to claim 1, wherein the source container revolving conveyer devices are provided as modules identical to each other so that they can be arranged adjacent to each other in a row in an arbitrary manner.

9. The sorting installation according to claim 1, wherein the source container revolving conveyer devices are provided as modules identical to each other so that they can be replaced by each other in an arbitrary manner.

10. The sorting installation according to claim 1, wherein the source container revolving conveyer devices are attachable to and detachable from each other in a linearly guided manner.

11. The sorting installation according to claim 1, wherein the source container revolving conveyer devices are attachable to and detachable from each other in a linearly guided manner in the conveying direction of supply and return lines of the source container conveying circuits.

12. The sorting installation according to claim 1, wherein a plurality of source containers are circularly conveyable.

13. The sorting installation according to claim 1, wherein the revolving operation of the respective source container revolving conveyer device is reversible in its direction so that the source containers, which are in the corresponding source container conveying circuit, are selectively conveyed in the one or in the other revolving direction.

14. A method for sorting articles from source containers into target containers by a sorting person being in a sorting area, wherein by means of a plurality of source container revolving conveyer devices arranged adjacent to the sorting area and respectively having a source container conveyer circuit, wherein a conveying circuit plane of the source container conveying circuit of the respective source container revolving conveyer device extends vertically and crosses the sorting area, a plurality of source containers per source container conveying circuit are supplied to the sorting person in the sorting area along the respective source container conveying circuit in a revolving and repeated manner until a desired number of articles are sorted from the respective source container into respective ones of the target containers, wherein the target containers are automatically supplied to and are automatically removed from the sorting person on a target container transport path which extends adjacent as well as in front of that frontal side of the source container conveying circuit which faces the sorting area.

15. The method according to claim 14, wherein the source containers in the respective source container conveying circuit are conveyed towards the sorting area in the one or in the other revolving direction in dependence on their distance to the sorting area.

16. A method for sorting articles from source containers into target containers by a sorting person located in a sorting area using a plurality of source container revolving conveyer devices arranged adjacent to the sorting area and respectively having a source container conveyer circuit, wherein a conveying circuit plane of the source container conveying circuit of the respective source container revolving conveyer device extends vertically and crosses the sorting area, the method comprising:
supplying a plurality of source containers for each source container conveying circuit to the sorting person in the sorting area along the respective source container conveying circuit in a revolving and repeated manner until a desired number of articles are sorted from the respective source container into respective ones of the target containers, and
automatically supplying and automatically removing the target containers for the sorting person on a target container transport path which extends adjacent as well as in front of that frontal side of the source container conveying circuit which faces the sorting area.

17. The method according to claim 16, wherein the source containers in the respective source container conveying circuit are conveyed towards the sorting area in a revolving direction in dependence on their distance to the sorting area.
